(19) United States
(12) Patent Application Publication
(10) Pub. No.: US 2025/0124206 A1
(43) Pub. Date: Apr. 17, 2025

(54) DYNAMIC VOLTAGE DROP ANALYSIS USING SIMULTANEOUS SWITCHING

(71) Applicant: Advanced Micro Devices, Inc., Santa Clara, CA (US)

(72) Inventors: Antonio R. Todesco, Woodside, CA (US); Prashanth Muthu Swamy, Milpitas, CA (US); Hariram Ravindran, San Ramon, CA (US); Khoa D. Nguyen, Gilroy, CA (US)

(73) Assignee: Advanced Micro Devices, Inc., Santa Clara, CA (US)

(21) Appl. No.: 18/917,374

(22) Filed: Oct. 16, 2024

Related U.S. Application Data
(60) Provisional application No. 63/590,713, filed on Oct. 16, 2023.

(51) Int. Cl. G06F 30/367; G06F 119/06

(52) U.S. Cl. CPC G06F 30/367; G06F 2119/06

(57) ABSTRACT

Dynamic voltage drop analysis for a circuit design includes generating, by computer hardware, bias information for a circuit design. The bias information specifies switching information for a plurality of instances of one or more standard cells of the circuit design. A schedule specifying switching for the plurality of instances of the circuit design is generated by the computer hardware based on the bias information. A dynamic voltage analysis is performed by the computer hardware on the circuit design to generate dynamic voltage analysis results by switching the plurality of instances of the circuit design based on the schedule.

### TECHNICAL FIELD

This disclosure relates to integrated circuits (ICs) and, more particularly, to dynamic voltage or IR drop analysis.

### BACKGROUND

Voltage drop, also referred to as “IR” drop in reference to current “I” and resistance “R,” refers to the voltage drop that may be observed in metal wires of the power grid of an integrated circuit (IC) between the voltage source and the power pins of standard cells and/or instances of standard cells in the IC. IR drop is an important metric as it is determinative of a variety of different attributes of a physical realization of a circuit design as an IC. For example, IR drop can be indicative of various different IC characteristics including, but not limited to, speed of the standard cells of the IC, power dissipation of the IC, overall performance of the IC, and even failure of the IC.

Static IR drop refers to an average voltage drop observed in the metal wires of the power grid of the IC. Dynamic IR drop refers to the voltage drop that may be observed in the IC due to switching activity of circuits (e.g., transistors) of the circuit design. Dynamic voltage drop arises as a consequence of increasing demand for current from the power supply due to the switching activity of components within the IC during operation.

Dynamic IR drop may be simulated for a circuit design that is to be physically realized as an IC to determine whether the observed levels of IR drop violate design rules and, as such, are problematic in terms of attaining particular design goals and/or a minimum level of expected reliability from the IC. Conventional analysis tools for measuring dynamic IR drop of a circuit design often provide inaccurate assessments of dynamic power analysis. Such is the case as conventional tools often lack an understanding of, and fail to account for, the impact of simultaneous switching on dynamic power.

### SUMMARY

In one or more embodiments, a method includes generating, by computer hardware, bias information for a circuit design. The bias information specifies switching information for a plurality of instances of one or more standard cells of the circuit design. The method includes generating, by the computer hardware, a schedule specifying switching for the plurality of instances of the circuit design based on the bias information. The method includes performing, by the computer hardware, a dynamic voltage analysis on the circuit design to generate dynamic voltage analysis results by switching the plurality of instances of the circuit design based on the schedule.

The foregoing and other implementations can each optionally include one or more of the following features, alone or in combination. Some example implementations include all the following features in combination.

In some aspects, generating the bias information for the circuit design includes calculating measures of risk for the plurality of instances, ranking the plurality of instances based on the measures of risk, and assigning switching weights to one or more of the plurality of instances based on the measures of risk.

In some aspects, the schedule is generated based on the switching weights.

In some aspects, the switching weights increase a probability of two or more instances of the plurality of instances switching simultaneously during the dynamic voltage analysis.

In some aspects, the bias information for the circuit design includes a victim instance of the plurality of instances and a list of one or more aggressor instances for the victim instance.

In some aspects, the schedule includes instructions causing the victim instance to switch simultaneously with the one or more aggressor instances.

In some aspects, the bias information for the circuit design is generated on a per-instance basis and, for each instance, is based on temporal proximity.

In some aspects, the bias information for the circuit design is generated on a per-instance basis and, for each instance, is based on spatial proximity.

In some aspects, the method includes modifying the circuit design in response to the dynamic voltage analysis results indicating a voltage drop violation.

In one or more embodiments, a system includes a memory capable of storing program instructions and a hardware processor capable of executing the program instructions to perform operations. The operations include generating bias information for a circuit design. The bias information specifies switching information for a plurality of instances of one or more standard cells of the circuit design. The operations include generating a schedule specifying switching for the plurality of instances of the circuit design based on the bias information. The operations include performing a dynamic voltage analysis on the circuit design to generate dynamic voltage analysis results by switching the plurality of instances of the circuit design based on the schedule.

The foregoing and other implementations can each optionally include one or more of the following features, alone or in combination. Some example implementations include all the following features in combination.

In some aspects, generating the bias information for the circuit design includes calculating measures of risk for the plurality of instances, ranking the plurality of instances based on the measures of risk, and assigning switching weights to one or more of the plurality of instances based on the measures of risk.

In some aspects, the schedule is generated based on the switching weights.

In some aspects, the switching weights increase a probability of two or more instances of the plurality of instances switching simultaneously during the dynamic voltage analysis.

In some aspects, the bias information for the circuit design includes a victim instance of the plurality of instances and a list of one or more aggressor instances for the victim instance.

In some aspects, the schedule includes instructions causing the victim instance to switch simultaneously with the one or more aggressor instances.

In some aspects, the bias information for the circuit design is generated on a per-instance basis and, for each instance, is based on temporal proximity.

In some aspects, the bias information for the circuit design is generated on a per-instance basis and, for each instance, is based on spatial proximity.

In some aspects, the operations include modifying the circuit design in response to the dynamic voltage analysis results indicating a voltage drop violation.

In one or more embodiments, a computer program product includes one or more computer readable storage mediums having program instructions embodied therewith. The program instructions are executable by computer hardware to cause the computer hardware to perform executable operations. The operations include generating bias information for a circuit design. The bias information specifies switching information for a plurality of instances of one or more standard cells of the circuit design. The operations include generating a schedule specifying switching for the plurality of instances of the circuit design based on the bias information. The operations include performing a dynamic voltage analysis on the circuit design to generate dynamic voltage analysis results by switching the plurality of instances of the circuit design based on the schedule.

The foregoing and other implementations can each optionally include one or more of the following features, alone or in combination. Some example implementations include all the following features in combination.

In some aspects, generating the bias information for the circuit design includes calculating measures of risk for the plurality of instances, ranking the plurality of instances based on the measures of risk, and assigning switching weights to one or more of the plurality of instances based on the measures of risk.

In some aspects, the schedule is generated based on the switching weights.

In some aspects, the switching weights increase a probability of two or more instances of the plurality of instances switching simultaneously during the dynamic voltage analysis.

In some aspects, the bias information for the circuit design includes a victim instance of the plurality of instances and a list of one or more aggressor instances for the victim instance.

In some aspects, the schedule includes instructions causing the victim instance to switch simultaneously with the one or more aggressor instances.

In some aspects, the bias information for the circuit design is generated on a per-instance basis and, for each instance, is based on temporal proximity.

In some aspects, the bias information for the circuit design is generated on a per-instance basis and, for each instance, is based on spatial proximity.

In some aspects, the operations include modifying the circuit design in response to the dynamic voltage analysis results indicating a voltage drop violation.

In one or more embodiments, a computer program product includes one or more computer readable storage mediums having program instructions embodied therewith. The program instructions are executable by computer hardware to cause the computer hardware to perform executable operations.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an architecture that may be executed by a data processing system for performing dynamic voltage (IR) analysis in accordance with one or more embodiments of the disclosed technology.

FIG. 2 is a method that may be performed through execution of the architecture of FIG. 1 in accordance with one or more embodiments of the disclosed technology.

FIG. 3 is another method that may be performed through execution of the architecture of FIG. 1 in accordance with one or more embodiments of the disclosed technology.

FIG. 4 is another method that may be performed through execution of the architecture of FIG. 1 in accordance with one or more embodiments of the disclosed technology.

FIGS. 5A, 5B, and 5C are histograms illustrating certain operative features of the risk-based technique described herein in connection with FIG. 3 in accordance with one or more embodiments of the disclosed technology.

FIG. 6 is a scatter plot illustrating certain operative features of the risk-based technique described herein in connection with FIG. 3 in accordance with one or more embodiments of the disclosed technology.

FIG. 7 is another histogram illustrating certain operative features of the risk-based approach described in connection with FIG. 3 and a voltage-based approach described in connection with FIG. 4 in accordance with one or more embodiments of the disclosed technology.

FIG. 8 is a scatter plot illustrating certain operative features of the architecture of FIG. 1 in accordance with one or more embodiments of the disclosed technology.

FIG. 9 illustrates an example implementation of a data processing system for use with the inventive arrangements described within this disclosure.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to integrated circuits (ICs) and, more particularly, to dynamic voltage (IR) drop analysis. In accordance with the inventive arrangements described within this disclosure, methods, systems, and computer-program products capable of performing dynamic power analysis for a circuit design are disclosed. The inventive arrangements are capable of performing dynamic power analysis, e.g., dynamic IR analysis, to determine IR drops for a circuit design with increased accuracy compared to conventional or available dynamic IR analysis tools.

Conventional dynamic IR analysis tools tend to focus on individual standard cells, or instances thereof, of the circuit design and ensure that some minimum percentage of the instances are exercised at least one time for purposes of the analysis. Within this disclosure the term “instance” is used to refer to a particular implementation or occurrence of a given standard cell in a circuit design and/or IC. Instances may refer to two or more occurrences of a single or same standard cell or to two or more occurrences of two or more different standard cells.

A standard cell refers to a reusable unit of circuit design that may be used as a building block for constructing circuits and/or electronic systems in ICs. Standard cells may have standardized or same heights thereby allowing the use of instances of the standard cells in rows to form the IC. A standard cell, for example, may define a particular layout of circuit components (e.g., transistors) and interconnect structures. As an illustrative and non-limiting example, a standard cell may specify a reusable circuit structure implementation of a Boolean logic function such as AND, OR, XOR, XNOR, an inverter, or a storage function (e.g., a flip-flop or latch).

Conventional dynamic IR vector-less analysis tools exercise (e.g., switch) instances of the circuit design during the analysis based on some defined probability assigned to the respective instances. For example, given a circuit design with 1.5 million instances, a conventional dynamic IR analysis tool may have a goal of exercising some minimum percentage of the instances, e.g., 90% of the instances, to obtain suitable test coverage. The conventional dynamic IR vector-less analysis tools are not designed to focus on simultaneous switching of instances in the circuit design being evaluated. That is, the particular instances and combinations of instances that do switch simultaneously are not considered or evaluated so long as the minimum number of instances are exercised. Conventional dynamic IR analysis tools do not, for example, consider the probability of a particular group of instances switching at the same time thereby resulting in a potentially outsized impact of the switching activity of such instances on the dynamic IR drop of the circuit design and consequently on the physical realization of that circuit design as an IC.

In one or more example implementations, a system is capable of biasing a dynamic IR engine to exercise selected instances of a circuit design such that the selected instances are switched simultaneously during the dynamic IR analysis.

In one or more embodiments, the selected instances are determined or chosen using a risk-based approach. Those instances determined to be of high risk are instances that should be exercised concurrently during the dynamic IR analysis. These “high risk” instances may be selected. Operation of a dynamic IR analysis engine may be biased so that the selected instances switch more often during the dynamic IR analysis. By increasing the amount of switching of the selected, or high risk, instances, the likelihood that groupings of two or more of the selected instances will switch simultaneously is increased. As such, the dynamic IR analysis performed achieves greater test coverage for the circuit design.

In one or more embodiments, the selected instances may be determined using a voltage-based approach where the classification of an instance as a victim instance or an aggressor instance determines which instances are exercised simultaneously during the dynamic IR analysis. For example, for each instance of the circuit design, that instance may be considered a victim instance. The system is capable of determining which other instances of the circuit design behave as aggressor instances toward that victim instance. This analysis may be performed on a per instance basis so that for each instance, the aggressor instances for that instance are identified. The aggressor-victim information may be provided to the dynamic IR analysis engine to bias the engine to ensure that when a selected instance is exercised (e.g., switched), the aggressor instances for the selected instance are exercised simultaneously (e.g., on a same clock cycle and/or on a same edge or portion of a same clock cycle) to more accurately measure IR drop in the circuit design.

The results from the dynamic IR analysis described herein may be provided to design teams and/or other Electronic Design Automation (EDA) tools to influence, guide, and/or manage processes such as placement, routing, and the like. Thus, changes in the circuit design affected by placement, routing, and/or the like may be influenced by the results generated from the dynamic IR analysis.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

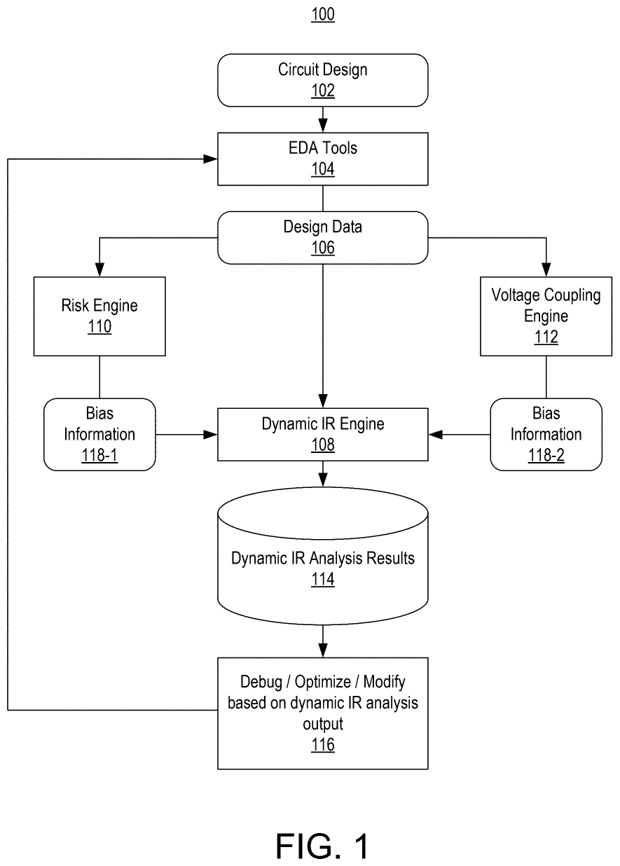

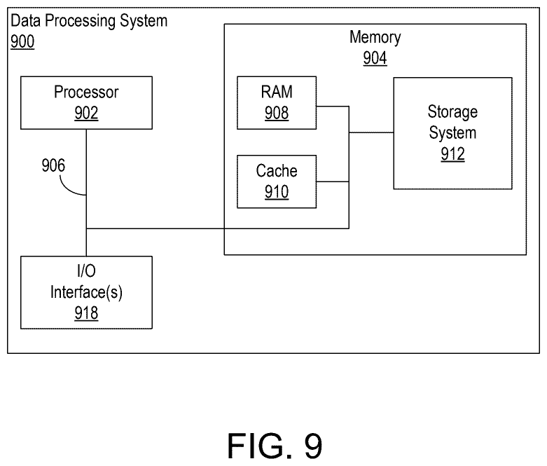

FIG. 1 illustrates an architecture 100 that may be executed by a data processing system for performing dynamic IR analysis in accordance with one or more embodiments of the disclosed technology. A computer is an example of a data processing system. Architecture 100 may be implemented as computer program instructions, e.g., program code, that is executable by a data processing system to perform the various operations described within this disclosure. An example of a data processing system that may be used to execute architecture 100 is described in connection with FIG. 9.

In the example of FIG. 1, architecture 100 is capable of operating on a circuit design 102. Circuit design 102 may be provided to one or more Electronic Design Automation (EDA) tools 104. EDA tools 104 may be upstream tools implemented as computer-based tools that are capable of performing operations such as a design flow (e.g., synthesis, placement, routing, and/or layout generation) to generate design data 106. Design data 106 may include any of a variety of different types of data including, but not limited to, circuit design 102 itself, e.g., a netlist, one or more layout files specifying layout information (e.g., placement and/or routing data) for instances of the standard cells of circuit design 102, and one or more timing files specifying timing information for circuit design 102 as determined based on the layout information. Design data 106 may be provided to a dynamic IR engine 108. In one or more examples, dynamic IR engine 108 is implemented as a vector-less IR engine.

In the example of FIG. 1, different engines illustrated as a risk engine 110 and a voltage coupling engine 112 are illustrated. Each engine is capable of generating bias information 118 that may be provided to dynamic IR engine 108. In general, bias information specifies switching information for instances of circuit design 102 and may be used by dynamic IR engine 108 to generate a schedule. Dynamic IR engine 108 performs dynamic IR analysis by switching instances of circuit design 102 in accordance with, or as specified by, the schedule. The schedule includes instructions causing dynamic IR engine 108 to switch certain instances (e.g., high risk instances) more frequently or causing other instances (e.g., victim instance and its aggressor instances) to switch simultaneously.

In one or more embodiments, a risk engine 110 is included in architecture 100. Risk engine 110 is capable of generating bias information 118-1 using a risk-based technique. Bias information 118-1 is used to bias operation of dynamic IR engine 108. In one or more examples, bias information 118-1 provided to dynamic IR engine 108 from risk engine 110 includes switching weights that are assigned to one or more of the instances of the standard cell(s) of circuit design 102.

For example, risk engine 110 is capable of performing an analysis of instances of circuit design 102 to determine those instances considered to be of at least a minimum predetermined risk. Risk engine 110 is capable of ranking the instances according to the respective determined risks. Risk engine 110 also is capable of assigning a switching weight to one or more of the instances based on the risks. The switching weights for particular instances of circuit design 102, which may be provided to dynamic IR engine 108 as bias information 118-1, as interpreted by dynamic IR engine 108 during operation, cause dynamic IR engine 108 to exercise or switch those instances considered to be of higher risk (e.g., those instances having switching weights determined by risk engine 110 or non-zero switching weights depending on the implementation as specified by bias information 118-1 more often. This increases the likelihood that high risk instances will switch simultaneously during the dynamic IR analysis performed by dynamic IR engine 108.

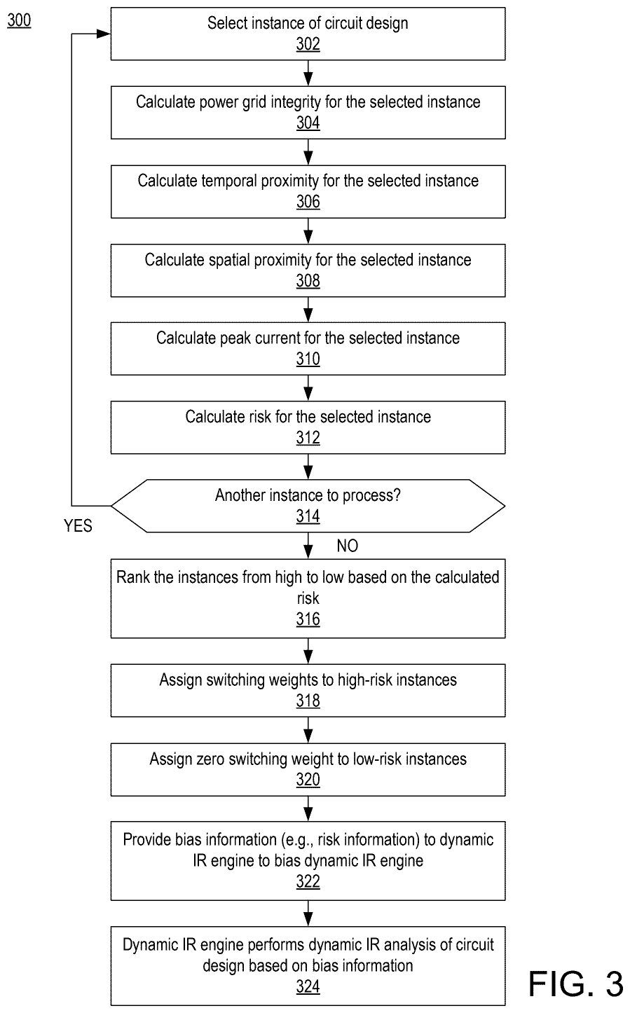

For purposes of illustration, risk engine 110 is capable of calculating a risk for one or more or each instance of circuit design 102 as a function of one or more parameters to be described in greater detail hereinbelow. Risk engine 110 is capable of ranking the instances based on the determined risk from high to low. Risk engine 110 is capable of assigning a switching weight to those instances considered high-risk. In one or more examples, risk engine 110 may ignore those instances considered to be of low-risk by assigning no switching weight or a zero switching weight to such instances. The information generated by risk engine 110, e.g., the switching weights, is provided to dynamic IR engine 108 as bias information 118-1. Further details relating to operation of risk engine 110 in coordination with dynamic IR engine 108 are described in connection with FIG. 3.

In one or more example implementations, a voltage coupling engine 112 is included in architecture 100. Voltage coupling engine 112 is capable of generating bias information 118-2 using a voltage-based technique. Bias information 118-2 is used to bias operation of dynamic IR engine 108. In one or more examples, bias information 118-2 provided to dynamic IR engine 108 from voltage coupling engine 112 includes voltage coupling information for one or more of the instances of the standard cell(s) of circuit design 102.

For example, voltage coupling engine 112 is capable of performing an analysis of instances of circuit design 102 to determine those instances considered to be victim instances and those instances considered to be aggressor instances. For example, for a selected instance considered to be a victim instance, the selected instance may have a set of one or more other instances that are considered to be aggressors. The aggressor instances, when switched at the same time as the victim instance, have an impact on the IR drop of the victim instance.

Voltage coupling engine 112 is capable of ranking the victim instances based on the amount of IR drop of the victim instance that is attributable to the aggressor instances of the victim instance. In one or more examples, the ranking may be performed based on victim instances having the largest portion of a normalized IR drop caused by aggressor instances. Voltage coupling engine 112 is capable of providing bias information 118-2 to dynamic IR engine 108, where bias information 118-2 specifies the voltage coupling information which may include the list of victim instances ordered from largest to smallest IR drop or those victim instances with worst IR drops (e.g., the worst N victim instances where N is an integer value or those victim instances with an IR drop above a threshold IR drop). Accompanying the list of victim instances included in bias information 118-2 is a list of the aggressor instance(s) for each victim instance. Dynamic IR engine 108 may be biased, or configured, to ensure that, during the dynamic IR analysis, the aggressor instances of a given victim instance are scheduled to switch, and do switch, simultaneously with the given victim instance. This increases the likelihood that dynamic IR engine 108 is able to find the worst-case IR drops for circuit design 102.

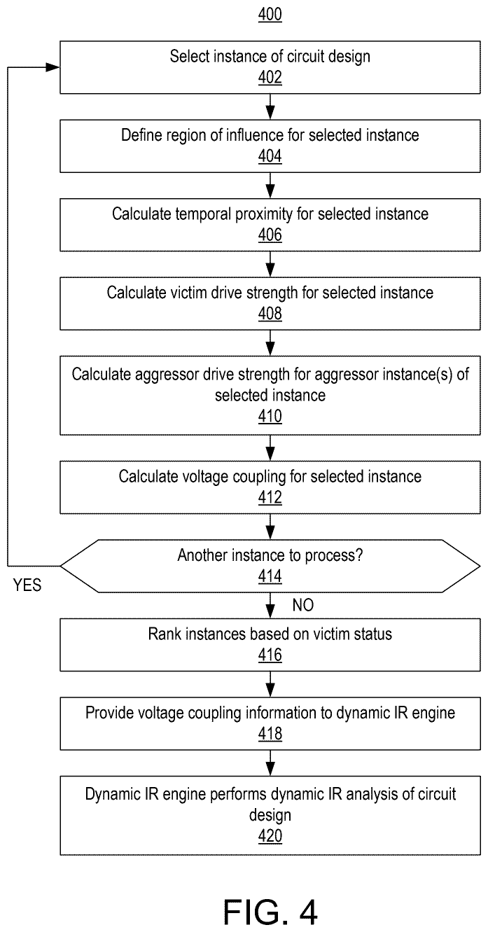

For purposes of illustration, voltage coupling engine 112 is capable of setting a region of influence for instances of circuit design 102. In one or more examples, the region of influence may be set based on the design. Voltage coupling engine 112 is capable of detecting instances with matching timing windows and classifying the instances as victim instances or aggressor instances based on various parameters that may include, but are not limited to, drive strength and/or power. Voltage coupling engine 112 also may consider other dynamic parameters such as slew and load. For the various instances, voltage coupling engine 112 calculates the voltage coupling and provides the voltage coupling data to dynamic IR engine 108 as bias information 118-2. Further details relating to operation of voltage coupling engine 112 in coordination with dynamic IR engine 108 are described in connection with FIG. 4.

In one or more example implementations, either risk engine 110 or voltage coupling engine 112 may be used with dynamic IR engine 108. That is, if risk engine 110 is used to generate and provide bias information 118-1, voltage coupling engine 112 may be omitted from architecture 100. Conversely, if voltage coupling engine 112 is used to generate and provide bias information 118-2, risk engine 110 may be omitted from architecture 100. In one or more other examples described hereinbelow, both risk engine 110 and voltage coupling engine 112 may be used to provide bias information 118-1 and bias information 118-2 to dynamic IR engine 108.

Dynamic IR engine 108 is capable of operating using received bias information 118 (e.g., in reference to bias information 118-1 and/or bias information 118-2) to generate dynamic IR analysis results 114, which may be stored in a data storage device. Dynamic IR analysis results 114 may specify an IR drop for one or more or each instance of circuit design 102.

In one or more embodiments, dynamic IR analysis results 114 may be provided to design teams and used to debug, optimize, and/or modify circuit design 102 as illustrated in block 116. The debugging/optimization/modification may be performed to ensure that any determined IR drops for circuit design 102 are within established limits per a design specification, for example.

In one or more other embodiments, dynamic IR analysis results 114 may be provided to EDA tools 104 (e.g., placer, router, or the like) as part of a feedback and/or iterative process that may be automated (e.g., automatic). In that case, EDA tools 104 may perform operations such as placement and/or routing using dynamic IR analysis results 114 to adapt the placement and/or routing solution so as to achieve improved dynamic IR analysis results 114 (e.g., reduced IR drop for those instances having an IR drop exceeding a predetermined threshold). As noted, the process may iterate automatically until each instance meets the IR drop requirements and/or for a maximum number of iterations.

Examples of design techniques that may reduce IR drop for a selected instance may include moving the selected instance or one or more surrounding instances (e.g., aggressor instances) so that the effect of the selected instance and the surrounding instance(s) switching simultaneously is reduced. The selected instance and/or surrounding instance(s) may be moved to increase the distance between them.

Having performed any necessary debugging, optimizations, and/or modifications to circuit design 102, circuit design 102 may be implemented as an IC. That is, circuit design 102 may be processed through a design flow using Dynamic IR analysis results 114 as described with the result being physically realized as an IC. The resulting IC, by virtue of the dynamic IR analysis results 114 generated, will benefit from one or more of the following: improved timing, reduced power consumption, improved reliability, reduced chance of suffering a silicon failure.

The inventive arrangements described herein, whether using risk engine 110 and/or voltage coupling engine 112, are capable of detecting a larger number of IR drop violations of circuit design 102 that would be missed were conventional dynamic IR analysis tools used. Such IR drop violations are missed in conventional approaches as such approaches fail to cause relevant instances to switch simultaneously thereby underestimating the IR drop of instances of the circuit design. The inventive arrangements also serve to reduce the number of IR drop violations detected in subsequent Engineering Change Order runs. That is, the number of IR drop violations detected sooner is larger thereby reducing the number of design iterations needed to detect and fix further IR drop violations for the circuit design in later development stages. This results in faster design closure and a less costly process. Another benefit of the inventive arrangements is that the increased accuracy in IR drop violation detection permits reduced margins, thereby reducing the amount of “over-design” necessary. This can reduce the cost of manufacturing the IC.

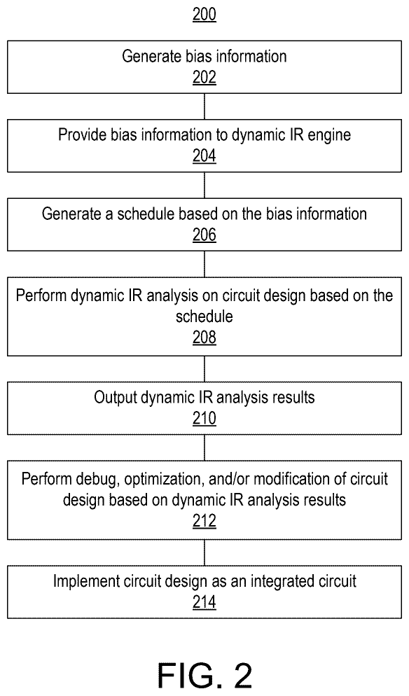

FIG. 2 is an example method 200 that may be performed through execution of architecture 100. In the example of FIG. 2, method 200 illustrates certain operative features of the example implementation of architecture 100 using either risk engine 110 or voltage coupling engine 112 or both risk engine 110 and voltage coupling engine 112. Method 200 may begin operation in a state where EDA tools 104 have generated design data 106.

In block 202, risk engine 110 generates bias information 118-1, voltage coupling engine 112 generates bias information 118-2, or both risk engine 110 and voltage coupling engine 112 may operate to generate bias information 118-1 and 118-2 in a coordinated manner described in greater detail hereinbelow.

In general, bias information specifies switching information for instances of one or more standard cells of circuit design 102 and may be used by dynamic IR engine 108 to generate a schedule. Dynamic IR engine 108 performs dynamic IR analysis by switching instances of circuit design 102 in accordance with, or as specified by, the schedule. The schedule includes instructions causing dynamic IR engine 108 to switch certain instances (e.g., high risk instances) more frequently or causing other instances (e.g., victim instance and its aggressor instances) to switch simultaneously.

In block 204, the relevant engine (e.g., 110 or 112 or both 110, 112) provides bias information 118 to dynamic IR engine 108. In block 206, bias information 118 is capable of generating a schedule based on the bias information 118 received from the relevant engine. In general, bias information specifies switching information for instances of circuit design 102 and may be used by dynamic IR engine 108 to generate the schedule. The switching information specifies, for example, which instances of circuit design 102 are to be switched simultaneously during dynamic IR analysis as performed by dynamic IR engine 108. The schedule includes or specifies instructions that cause dynamic IR engine 108 to switch certain instances (e.g., high risk instances) more frequently or causing other instances (e.g., victim instance and its aggressor instances) to switch simultaneously.

In block 208, dynamic IR engine 108 performs dynamic IR analysis using bias information 118. Bias information 118 biases operation of dynamic IR engine 108 to operate in a particular way. As biased, dynamic IR engine 108 switches selected instances of circuit design 102 (e.g., selected based on bias information 118) more often during the dynamic IR analysis thereby increasing the likelihood that high risk instances switch simultaneously during the analysis and/or ensures that selected instances switch simultaneously. In one or more embodiments, the increase in switching of the selected instances may be proportional to the risk for the instance. That is, an instance with a moderate risk will be switched more often than an instance with a lower risk but not as often as an instance with a high risk. In block 210, dynamic IR engine 108 outputs (e.g., stores) the dynamic IR analysis results 114 in a data storage device.

In block 212, debug, optimization, and/or modification of circuit design 102 may be performed based on the dynamic IR analysis results 114. In one or more examples, designers may use the provided dynamic IR analysis results 114 to reduce the resistance of those instances that are flagged with an IR drop violation. For example, one or more of the instances may be moved (e.g., re-placed), one or more of the instances may be re-routed, and/or one or more of the instances may be reduced in size.

In one or more embodiments, the aforementioned techniques may be performed automatically by the EDA tools 104. For example, the circuit design may be re-placed, re-routed, incrementally re-placed for only selected instances, and/or re-routed for only selected instances automatically by the EDA tools 104 using dynamic IR analysis results 114 as input which may flag or otherwise identify those instances that violate IR drop requirements for circuit design 102. Other techniques also may be used. In some cases, the EDA tools may implement automated optimizations and/or modifications of instances that are flagged by dynamic IR engine 108. For example, in one or more embodiments, one or more implementation tools may use the dynamic IR analysis results 114 as a parameter within a cost function that influences or dictates placement decisions and/or routing decisions for such instances.

In block 214, circuit design 102 may be implemented in an IC. For example, the circuit design as debugged, optimized, and/or modified based on the dynamic IR analysis results 114 may be implemented (e.g., physically realized, manufactured, or fabricated) as an IC.

FIG. 3 is a method 300 that may be performed through execution of architecture 100 in accordance with one or more embodiments of the disclosed technology. In the example of FIG. 3, method 300 illustrates certain operative features of the example implementation of architecture 100 using risk engine 110. Method 300 may begin operation in a state where upstream EDA tools 104 have generated design data 106.

The example of FIG. 3 illustrates a process in which instances of circuit design 102 may be evaluated on a per instance basis. In block 302, the risk engine 110 is capable of selecting an instance of circuit design 102.

In block 304, risk engine 110 is capable of calculating power grid integrity on a per instance basis. That is, risk engine 110 is capable of calculating a measure of power grid integrity for the selected instance of circuit design 102. Power grid integrity is a parameter, also referred to herein as “X1” or the “X1 parameter,” that specifies a measure of resistivity, e.g., in Ohms, of the power grid with respect to the selected instance. In one or more examples, the X1 parameter may be calculated or extracted from the power grid by calculating the resistance from the port of the selected instance to the closest voltage source. The lower the resistivity, the more robust the power grid. The power grid integrity of the selected instance is the effective resistance of that instance. In general, in regions of the IC (e.g., based on the layout information) where the power grid has higher integrity (lower resistance), the X1 parameter of the selected instance will have a lower contribution to the risk of the instance. In regions of the IC where the power grid has lower integrity (higher resistance), the X1 parameter of the instance will have a higher contribution to the risk of the instance.

In block 306, risk engine 110 is capable of calculating temporal proximity for the selected instance. That is, risk engine 110 is capable of calculating a measure of temporal proximity for the selected instance of circuit design 102. Within this disclosure temporal proximity may be measured or specified in picoseconds. Temporal proximity is a parameter, also referred to herein as “X2” or the “X2 parameter,” that specifies how close in time a selected instance switches with respect to another (e.g., target) instance.

Temporal proximity indicates whether the switching of the selected instance and the target instance occur simultaneously. For example, for a pair of instances in which the selected instance switches at the beginning of a clock cycle while the target instance switches at the end of the same clock cycle, the temporal proximity of the selected instance relative to the target instance will be low. In the case where the selected instance and the target instance both switch at the same time or point (e.g., on a same edge) of a clock cycle, the temporal proximity of the selected instance and the target instance will be high. A high temporal proximity for the selected instance indicates that switching activity of one or more other instances may interfere with the selected instance. For an instance to have an influence on the selected instance, the instance will need a temporal proximity less than or equal to a threshold temporal proximity. In one or more embodiments, the temporal proximity may require that the instance switch on the same edge of a clock cycle as the selected instance.

Typically, when calculating the temporal proximity of a selected instance with respect to a target instance, the distance between the selected instance and the target instance is considered such that temporal proximity of the two instances presumes that the target instance is within a predetermined distance, range, or area of the selected instance.

In one or more embodiments, the spatial proximity discussed in connection with block 308 below may be used to implement the predetermined distance checking performed for the temporal proximity parameter. For example, if the spatial proximity of a target instance relative to the selected instance is sufficiently far (e.g., larger than a threshold distance or outside of a given defined region of circuit design 102), risk engine 110 may make a decision that the target instance has no spatial proximity effect and/or no temporal proximity effect on the selected instance such that X2 is set to zero or disregarded. In that case, for target instances that are beyond the threshold distance from the selected instance, the temporal proximity of such target instances need not be calculated or considered and simply considered zero.

In one or more embodiments, the temporal proximity of the selected instance may be a compound measure in that temporal proximity may be a sum or other function of the temporal proximity of the selected instance to each of a plurality of other target instances that meet the conditions specified for temporal proximity and/or for spatial proximity.

In block 308, risk engine 110 is capable of calculating spatial proximity for the selected instance. That is, risk engine 110 is capable of determining one or more measures of spatial proximity for the selected instance of circuit design 102. Spatial proximity is a parameter, also referred to herein as “X3” or the “X3 parameter,” that specifies how close in distance the selected instance is to another (e.g., target) instance. Spatial proximity indicates whether the switching of the selected instance and the target instance are close enough, in terms of distance, such that the switching of the target instance may interfere with the switching of the selected instance.

In general, distance between an instance and a boundary or between two instances may be measured or specified in micrometers. In one or more embodiments, risk engine 110 calculates spatial proximity of the selected instance with respect to only those target instances located within a predetermined threshold distance or region of circuit design 102. For the target instances located farther away from the selected instance than the threshold distance, risk engine 110 need not compute the X3 parameter and may set the X3 parameter to zero, for example. In one or more other embodiments, risk engine 110 is capable of calculating the spatial proximity of the selected instance relative to each other instance of circuit design 102.

In one or more embodiments, the spatial proximity of the selected instance may be a compound measure in that spatial proximity may be a sum or other function of the spatial proximity of the selected instance to each of a plurality of other target instances that meet the conditions specified for spatial proximity.

In block 310, risk engine 110 is capable of calculating peak current for the selected instance. In one or more examples, the peak current may be obtained from a table, database, or other data structure generated by another EDA tool capable of performing circuit analysis to generate the peak currents. Peak current is a parameter, also referred to herein as “X4” or the “X4 parameter,” that specifies an estimate of the peak or maximum amount of current, e.g., in Amperes, consumed by a given instance. The lower the peak current for a given instance, the less the X4 parameter will contribute to the risk of the instance. Conversely, the higher the peak current of an instance, the more the X4 parameter will contribute to the risk of the instance.

In block 312, risk engine 110 is capable of calculating a risk for the selected instance based on the X1, X2, X3, and X4 parameters calculated in blocks 304, 306, 308, and/or 310. For example, risk engine 110 is capable of calculating a risk for each instance of circuit design 102 as a function where RISK=F (X1, X2, X3, X4) for each respective instance. In one example, the risk of a selected instance may be calculated as (a*X1+b*X2+c*X3+d*X4) where a, b, c, and d are constant scaling factors that may be applied to the respective parameters. In one or more other example implementations, the risk may be calculated as RISK=(a*X1*b*X2*c*X3*d*X4). Appreciably, the particular parameter or the coefficient of the parameter may be set to zero in those cases where that parameter is considered to have no effect on the risk of selected instance being considered.

In one or more embodiments, only instances that are considered both spatially proximate and temporally proximate to the selected instance are evaluated or even considered as contributing to the risk for the selected instance. For example, in calculating risk for the current instance, only instances that are both spatially proximate and temporally proximate as described herein may have an influence on risk of the selected instance as calculated by risk engine 110. Thus, the set of instances that may contribute risk to the selected instance (e.g., with respect to parameters X2 and X3) may include only those instances that are both spatially and temporally proximate to the selected instance. In that case, for any instances that are not both spatially and temporally proximate, such instances are not considered at all. In this regard, spatial and temporal proximity may be used as filters to limit the instances considered as contributing risk to the selected instance such that any instances not both spatially and temporally proximate to the selected instance may not contribute to the X2 or X3 parameters for the selected instance.

As discussed, in one or more example implementations, one or more or each of the X2 and X3 parameters for the selected instance may be calculated as the sum of such parameters for the selected instance with respect to each target instance of the selected instance located that is spatially proximate (e.g., within a predetermined distance of the selected instance and/or within a predetermined area surrounding the selected instance) and temporally proximate (e.g., switches simultaneously with the selected instance or within a predetermined amount of time of the selected instance). For example, the X2 parameter for a selected instance may be a composite value calculated as the sum of the X2 parameters for the selected instance as measured relative to each other target instance that is spatially proximate and that is temporally proximate. The same may be true for the X3 parametersuch that the function used to calculate risk described above uses composite versions of each of X2 and X3.

In one or more other example implementations, different combinations of the X1, X2, X3, and X4 parameters may be used to calculate risk. For example, other possible groupings of parameters used to calculate risk may include only: (X1, X2); (X1, X3); (X1, X4); (X1, X2, X3); (X1, X2, X4); (X1, X3, X4); or (X2, X3, X4).

In block 314, risk engine 110 determines whether there are any additional instances of circuit design 102 to be processed. In response to determining that one or more instances of circuit design 102 remain to be processed, method 300 loops back to block 302 to select a next instance for processing and continues execution. In response to determining that no further instances remain to be processed, method 300 continues to block 316.

In block 316, risk engine 110 is capable of ranking the instances of circuit design 102 based on the risk calculated for each respective instance in block 312. Risk engine 110 is capable of ranking the instances from low risk to high risk.

In block 318, risk engine 110 is capable of assigning a switching weight to the high-risk instances. For example, risk engine 110 may assign a switching weight to the N highest-risk instances, where N is a predetermined integer. In another example, risk engine 110 may assign a switching weight to each instance having a risk above a predetermined threshold. In another example, risk engine 110 may assign a switching weight to a predetermined percentage of instances starting with the highest risk instances. In one or more embodiments, the weights as assigned to instances may vary such that the higher the risk of a given instance, the higher the weight assigned to that instance.

In block 320, risk engine 110 is capable of assigning a zero value to the switching weight for the low-risk instances. That is, for any instance not deemed to be a high-risk instance in block 318, risk engine 110 is capable of assigning such instance a zero-switching weight.

In one or more example implementations, the switching weights may be normalized with respect to those instances considered high risk.

In block 322, risk engine 110 is capable of providing bias information 118-1, e.g., the risk information for each instance of circuit design 102 to dynamic IR engine 108. The bias information effectively specifies a switching weight that is interpreted by dynamic IR engine 108 during operation, e.g., while performing dynamic IR analysis.

As noted, bias information 118-1 specifies switching information for instances of circuit design 102 and may be used by dynamic IR engine 108 to generate a schedule. Dynamic IR engine 108 performs dynamic IR analysis by switching instances of circuit design 102 in accordance with, or as specified by, the schedule. The schedule includes instructions that cause dynamic IR engine 108 to switch certain instances (e.g., high risk instances) more frequently (e.g., simultaneously) than instances considered low risk or non-high risk.

In block 324, dynamic IR engine 108 performs dynamic IR analysis of circuit design 102 based on bias information 118-1. In doing so, dynamic IR engine 108 uses bias information 118-1 (e.g., risk information and/or switching weight in this example) received from risk engine 110. Bias information 118-1 biases the operation of dynamic IR engine 108. As biased, dynamic IR engine 108 switches the high-risk instances more often during the dynamic IR analysis, which increases the likelihood that the high-risk instances will switch simultaneously.

In one or more examples, dynamic IR engine 108 is capable of generating a schedule using bias information 118-1 (e.g., the switching weights) and exercising (e.g., switching) the instances based on the schedule. The schedule, as generated using the switching weights, increases the switching frequency for the high-risk instances thereby causing the high-risk instances to switch more often and increasing the likelihood that the instances switch simultaneously.

The higher the switching weight for an instance, the more often that instance is switched during the dynamic IR analysis. For example, the amount or frequency with which the high-risk instances are switched during dynamic IR analysis may be proportional to the switching weight assigned thereto such that higher switching weights cause the instance to switch more often than an instance with a lower switching weight. Those instances with zero valued switching weights may simply be treated in a conventional or a default manner. That is, such instances still may be switched, but do not have an increased probability of switching relative to a predetermined default switching frequency. By comparison, any non-zero switching weight may increase the probability of that instance switching over conventional dynamic IR analysis techniques or a default switching frequency. Larger switching weights may increase the probability of the instance switching (e.g., increase the switching frequency) more so than a lower switching weight relative to a default switching frequency).

The dynamic IR analysis generates IR drops for the instances of circuit design 102 based on simultaneous switching of groupings of the instances based on the switching weights. Thus, an IR drop may be generated for each instance. The use of bias information 118-1 by dynamic IR engine 108 allows dynamic IR engine 108 to obtain a more pessimistic, albeit accurate, measure of IR drop for the instances of circuit design 102.

In one or more example implementations, as part of the dynamic IR analysis, dynamic IR engine 108 is capable of comparing the IR drop calculated for each instance with a threshold IR drop. The threshold IR drop may be a design rule or specification to be met with the IC being developed, may be a global threshold IR drop, a cell-specific threshold IR drop, or an instance-specific threshold IR drop. An IR drop above the threshold is indicated by dynamic IR engine 108 as a violation and the instance is flagged by dynamic IR engine 108. The inventive arrangements are capable of detecting a larger number of IR drop violations than conventional techniques.

After block 324, blocks 210 and/or 212 of FIG. 2 may be performed. As discussed, the results output from dynamic IR engine 108 may be used or incorporated into further iterations of one or more operations of a design flow such as placement and/or routing and/or incremental versions of such operation performed on circuit design 102.

FIG. 4 is another method 400 that may be performed through execution of architecture 100 in accordance with one or more embodiments of the disclosed technology. In the example of FIG. 4, method 400 illustrates certain operative features of the example implementation of architecture 100 using voltage coupling engine 112. Method 400 may begin operation in a state where upstream EDA tools 104 have generated design data 106.

The example of FIG. 4 illustrates a process in which instances of circuit design 102 may be evaluated on a per instance basis. In block 402, voltage coupling engine 112 is capable of selecting an instance of circuit design 102.

In block 404, voltage coupling engine 112 is capable of defining a region of influence for the selected instance. The region of influence is a parameter, also referred to herein as “X5” or the “X5 parameter,” that specifies predetermined distance as measured from the selected instance in one or more or all directions or may be specified as a predetermined area (e.g., an oval, circle, rectangle, square, etc.) surrounding the selected instance where the selected instance may be located at the center of the predetermined area. Voltage coupling engine 112 is capable of evaluating other, e.g., target, instances that are within this region of influence for the selected instance. In one aspect, the region of influence may be set as a universal parameter that is used for each instance as evaluated throughout method 400. Accordingly, the region of influence specifies a set of target instances for the selected instance—i.e., those instances within the region of influence.

In one or more embodiments, the region of influence may be set to be equivalent or the same as spatial proximity as described in connection with FIG. 3. For example, the spatial proximity may define a particular distance or region around the selected instance. In determining whether other instances have an influence on the selected instance, such other instances must be located in the region of influence, or in other words, be spatially proximate to the selected instance.

In block 406, voltage coupling engine 112 is capable of calculating temporal proximity for the selected instance. Temporal proximity, e.g., the X2 parameter, may be calculated substantially as described herein in connection with FIG. 3. That is, temporal proximity may be calculated for the selected instance with respect to each target instance within the region of influence. In one or more embodiments, voltage coupling engine 112 is capable of detecting instances with matching timing windows. That is, voltage coupling engine 112 is capable of detecting those instances that switch simultaneously for a given clock cycle (e.g., both switch at the rising edge or the falling edge, for example). In this example, the timing window being the same refers to both instances switching on a same edge of the clock cycle. Those instances that switch simultaneously, e.g., on the same edge of the clock cycle, may be considered temporally proximate or have high temporal proximity while those that do not switch on the same clock edge are not temporally proximate or have a lower temporal proximity.

In block 408, voltage coupling engine 112 is capable of calculating victim drive strength for the selected instance. The victim drive strength is a parameter, also referred to herein as “X6” or the “X6 parameter,” that specifies an amount of current that the selected instance, referred to as the “victim instance,” is capable of carrying on its own without considering any other instances of the circuit design whether or not such other instances are within the region of influence or are temporally proximate. In other words, the victim drive strength for the selected instance is the voltage drop of the selected instance due to its current through its own resistance. Drive strength is related to the size of internal transistors of the selected instance. The larger the size of such internal transistors, the larger the drive strength and higher the current carried by the selected instance.

In block 410, voltage coupling engine 112 is capable of calculating aggressor drive strength for aggressor instance(s) of the selected instance. The aggressor drive strength is a parameter, also referred to herein as “X7” or the “X7 parameter,” that specifies an amount of current that an aggressor instance is capable of carrying. In one or more examples, drive strength, whether for a victim instance or an aggressor instance, may be specified or measured in Amperes. In one or more examples, drive strength, whether for a victim instance or an aggressor instance, may be specified in relative terms among different instances. For example, the drive strength may be specified as a numerical value, e.g., one instance has a drive strength that is 2× that of another instance or a baseline instance.

In block 410, for example, voltage coupling engine 112 is capable of calculating aggressor drive strength for each aggressor instance of the selected instance. In one or more examples, each instance that is located in the region of influence and that has a high temporal proximity to the selected instance (e.g., switches at the same time) may be considered an aggressor instance.

In block 412, voltage coupling engine 112 is capable of calculating voltage coupling information for the selected instance. Voltage coupling may arise in view of the victim-aggressor relationship between the selected instance and other instances of circuit design 102 considered aggressor instances. For example, the power generation grid has a shared resistance between victim instances and aggressor instances for circuit design 102. The voltage drop of the victim instance is due to the current carried through the victim instance's own resistance. The voltage drop of an aggressor instance that is induced in the victim instance is due to a partial flow of current of the aggressor instance through the shared resistance with the victim instance.

In one or more embodiments, for the selected instance, voltage coupling engine 112 treats the instance as a victim instance. Accordingly, for purposes of discussion in block 412, the selected instance is considered synonymous with the victim instance. Voltage coupling engine 112 is capable of evaluating the impact of aggressor instances (e.g., instances within the same timing window and within the region of influence for the selected instance) on the victim instance. Voltage coupling engine 112 calculates the impact, e.g., change in IR drop, for the victim instance due to the switching activity of the victim instance itself and the impact on IR drop that is due to the switching activity of the other aggressor instances.

As an illustrative example, for the victim instance, voltage coupling engine 112 collects the aggressor instances for the selected instance, e.g., the victim instance. For purposes of calculating voltage, voltage coupling engine 112 is capable of calculating resistance and current as previously discussed in connection with FIG. 3. For example, resistance may be calculated from the port of the selected instance to the closest voltage source for the selected instance. Current may be calculated by obtaining the current for the selected instance from pre-characterized models or tables. Voltage may be calculated (I*R) for the selected instance. For the selected instance, e.g., the victim instance, voltage coupling engine 112 may sum the voltages of each aggressor instance for the victim instance with the voltage of the victim instance itself. The amount of the voltage for the victim instance attributable to aggressor instances may be calculated (e.g., by way of voltage coupling) versus the amount that is self-induced.

In one or more embodiments, as part of block 412, voltage coupling engine 112 is capable of considering or accounting for dynamic information. Voltage coupling engine 112 is capable of accounting for dynamic information in calculating voltage for the selected instance. Dynamic information is a parameter or collection of parameters, also referred to herein as “X8” or the “X8 parameter,” that specifies one or more attributes of dynamic switching. Dynamic information may include, but is not limited to, slew, number of loads, and load capacitance.

For example, voltage coupling engine 112 is capable of accounting for a dynamic parameter such as load capacitance in determining voltage coupling information for the selected instance. Load capacitance influences time to charge and has an impact on voltage coupling of an aggressor instance with respect to the victim instance. Voltage coupling engine 112 may also consider the size of the instance(s). Typically, aggressor instances are larger in size while victim instances tend to be smaller in size. For example, in block 412, adjustments may be made to the voltage coupling for the selected instance (e.g., increasing or decreasing) based on the dynamic (e.g., charge time) and other information as well as to the contribution to IR drop aggressor instances have on their respective victim instance. An aggressor instance with a longer charge time may induce less current through the victim instance than an aggressor instance with a faster charge time, for example.

In one or more embodiments, when detecting aggressor instances for the selected (e.g., victim) instance, only instances that are considered both spatially proximate and temporally proximate to the selected or victim instance are considered as aggressors and those instances that are not both spatially proximate and temporally proximate to the selected instance are disregarded. Thus, the set of aggressors for a selected instance may include only those instances that are both spatially and temporally proximate to the selected instance. In this regard, spatial and temporal proximity may be used as filters to limit the instances considered as aggressor instances for the selected instance such that any instances not both spatially and temporally proximate to the selected instance may not be an aggressor instance to the selected instance.

In block 414, voltage coupling engine 112 determines whether there are any additional instances of circuit design 102 to be processed. In response to determining that one or more instances of circuit design 102 remain to be processed, method 400 loops back to block 402 to select a next instance for processing and continues execution. In response to determining that no further instances remain to be processed, method 400 continues to block 416.

In block 416, voltage coupling engine 112 is capable of ranking the instances of circuit design 102 in terms of their victim status. Those instances considered most susceptible to other instances (e.g., that have a higher degree of normalized IR drop attributable to aggressor instances) may be ranked highest. Block 416 may be optional and omitted in some embodiments.

In block 418, voltage coupling engine 112 is capable of providing bias information 118-2 to dynamic IR engine 108. In this example, bias information 118-2 specifies the voltage coupling information calculated for each instance in block 412 to dynamic IR engine 108. The voltage coupling information may include a list of one or more victim instances. The voltage coupling information may include, for each victim instance, a list of the aggressor instance(s) for that victim instance.

In general, bias information 118-1 specifies switching information for instances of circuit design 102 and may be used by dynamic IR engine 108 to generate a schedule. Dynamic IR engine 108 performs dynamic IR analysis by switching instances of circuit design 102 in accordance with, or as specified by, the schedule. The schedule includes instructions that cause dynamic IR engine 108 to switch certain instances such as victim instance(s) and their aggressor instances simultaneously.

In block 420, dynamic IR engine 108 is capable of performing a dynamic IR analysis of circuit design 102 based on bias information 118-2. As noted, bias information 118-2 specifies voltage coupling information. In performing the dynamic IR analysis, dynamic IR engine 108 is capable of forcing victim instances to switch simultaneously with the aggressor instances for the respective victim instances.

In one or more examples, dynamic IR engine 108 is capable of generating a schedule that causes each victim instance to be exercised, e.g., switched, simultaneously with each of its aggressor instances. In this manner, instances that otherwise would not be exercised simultaneously may be exercised simultaneously by virtue of their aggressor relationship to a particular victim instance. In this implementation, it should be appreciated that any given instance may be a victim instance in that other instances act as aggressor instances for the instance while also acting as an aggressor instance toward other instances. This configuration ensures that what is considered to be a worst-case-scenario is implemented by dynamic IR engine 108.

In one or more example implementations, as part of the dynamic IR analysis, dynamic IR engine 108 is capable of comparing the IR drop calculated for each instance with a threshold IR drop. The threshold IR drop may be a design rule or specification to be met with the IC being developed, may be a global threshold IR drop, a cell-specific threshold IR drop, or an instance-specific threshold IR drop. An IR drop above the threshold is indicated by dynamic IR engine 108 as a violation and the instance is flagged by dynamic IR engine 108. The inventive arrangements are capable of detecting a larger number of IR drop violations than conventional techniques.

After block 420, blocks 210 and/or 212 may be performed. As discussed, the results output from dynamic IR engine 108 may be used or incorporated into further iterations of one or more operations of a design flow such as placement and/or routing and/or incremental versions of such operation performed on circuit design 102.

In one or more other embodiments, risk engine 110 and voltage coupling engine 112 may be used in combination and/or in coordination with one another to generate bias information 118-1 and 118-2 and provide both to dynamic IR engine 108. In illustration, the example method illustrated in FIG. 3 may be performed to calculate a risk for each instance of circuit design 102. The instances may be sorted according to risk. The example method illustrated in FIG. 4 may then be performed but only for those instances considered to be high risk from the process of FIG. 3 (e.g., only for those instances having a risk above a particular threshold, for the N highest risk instances, etc.). Biasing may then proceed using the output from FIG. 4. In this example, the risks generated from FIG. 3 may be used without performing the operations that assign a weight to the instances as the risks are used only to filter (e.g., limit or select) the list of instances that are operated on using the process illustrated in FIG. 4.

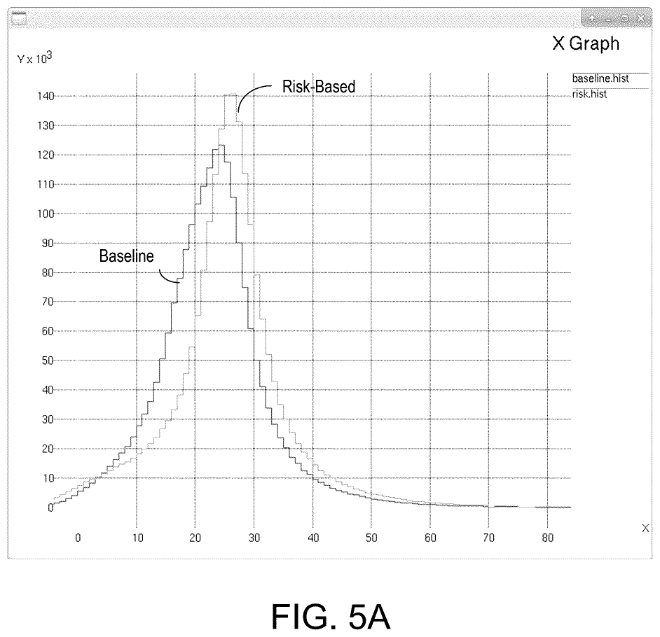

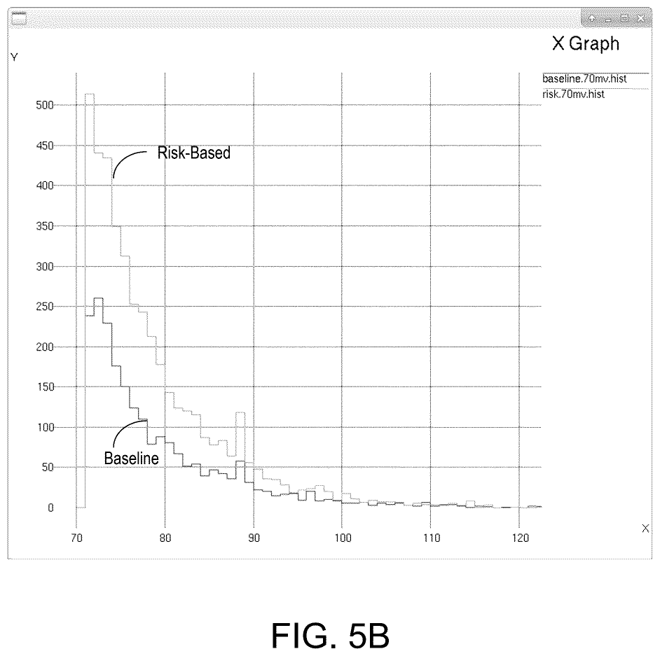

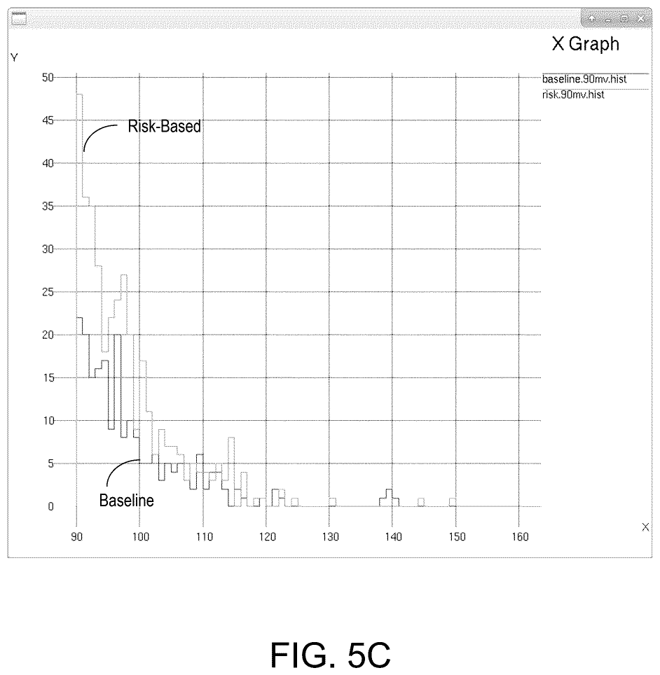

FIGS. 5A, 5B, and 5C illustrate a baseline histogram generated using conventional dynamic IR analysis techniques and a histogram generated using the risk-based approach described in connection with FIG. 3 for a circuit design under test. In each case, it can be seen that the histogram generated using the risk-based approach is shifted to the right and illustrates that the inventive arrangements detect more IR drop violations (e.g., more violating instances) than the conventional techniques.

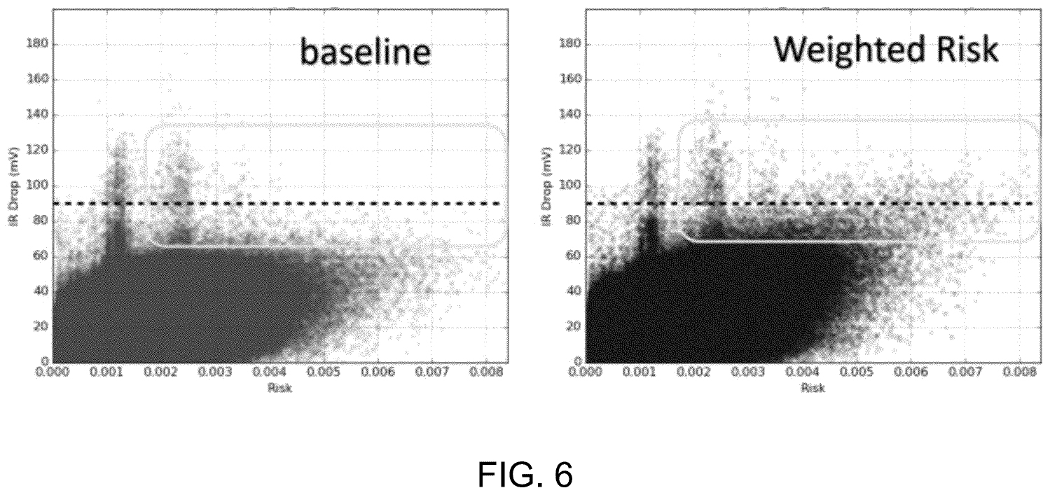

FIG. 6 illustrates that the risk-based technique described herein in connection with FIG. 3 detects a larger number of IR drop violations than the baseline generated using a conventional dynamic IR analysis technique for a circuit design under test. The plot on the left, corresponding to conventional dynamic IR analysis, has fewer points above the 90 mV threshold line than the plot on the right, which is illustrative of the risk-based approach that utilizes risk engine 110 as described in connection with FIG. 3.

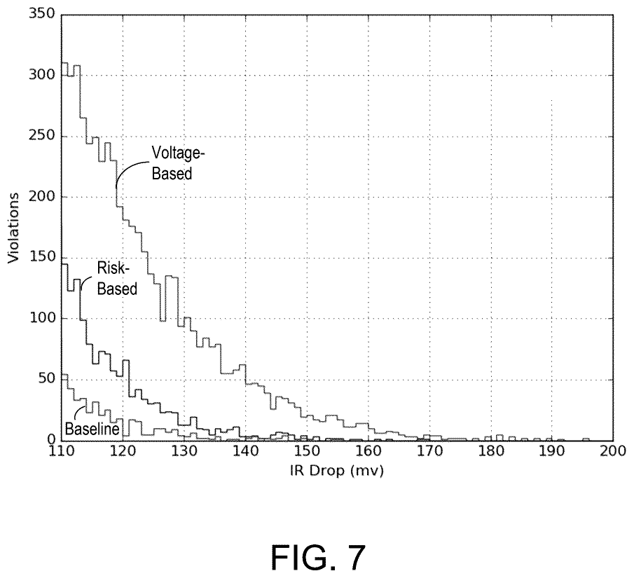

FIG. 7 is another histogram illustrating the risk-based approach described in connection with FIG. 3, the voltage-based approach described in connection with FIG. 4, and the baseline generated using a conventional dynamic IR analysis technique for a circuit design under test. As illustrated, both the risk-based and the voltage-based techniques detect a larger number of IR drop violations than the baseline, with the voltage-based approach outperforming the risk-based approach.

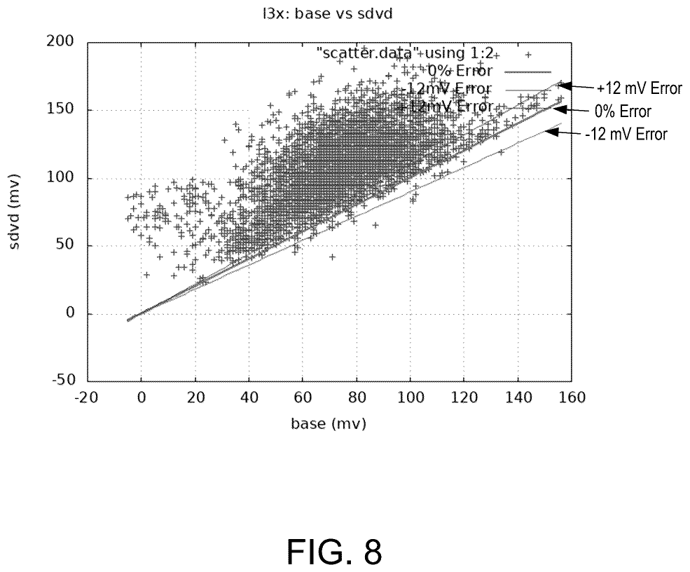

FIG. 8 is a scatter plot illustrating that a larger number of IR drop violations are detected shown as the points located above the “0% Error” line. For purposes of illustration, −12 mV error and +12 mV error lines are shown.

FIGS. 5-8 illustrate that while designers may not be able to reliably predict which instances of a given circuit design will switch under different test conditions, applications, and/or in real-world environments, the inventive arrangements described herein ensure that those instances of greater interest (e.g., risk or voltage coupling) are exercised concurrently or caused to switch simultaneously.

The inventive arrangements described herein provide a variety of benefits compared to conventional approaches. For example, both of the risk-based and voltage-based techniques are capable of detecting more potential real IR violations typically overlooked by conventional dynamic IR analysis techniques. By detecting more real IR violations earlier (e.g., in a single iteration cycle), the analysis cycle may be shortened due to the greater test coverage. This leads to faster design closure. This also reduces the risk of further place and route iterations for finalizing the circuit design (e.g., design closure). Margins may be reduced as discussed. Further, the risk of silicon failure in the manufactured IC is reduced.

In one or more other example implementations, a simplified model of the same or similar techniques can be executed in early stages of the circuit design (in early design cycles) to preemptively identify hotspots.

FIG. 9 illustrates an example implementation of a data processing system 900. As defined herein, the term “data processing system” means one or more hardware systems configured to process data, each hardware system including at least one processor and memory, wherein the processor is programmed with computer-readable instructions that, upon execution, initiate operations. Data processing system 900 can include a processor 902, a memory 904, and a bus 906 that couples various system components including memory 904 to processor 902.

Processor 902 may be implemented as one or more processors. In an example, processor 902 is implemented as a central processing unit (CPU). Processor 902 may be implemented as one or more circuits, e.g., a hardware processor, capable of carrying out instructions contained in program code. The circuit may be an integrated circuit or embedded in an integrated circuit. Processor 902 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, and the like.

Bus 906 represents one or more of any of a variety of communication bus structures. By way of example, and not limitation, bus 906 may be implemented as a Peripheral Component Interconnect Express (PCIe) bus. Data processing system 900 typically includes a variety of computer system readable media. Such media may include computer-readable volatile and non-volatile media and computer-readable removable and non-removable media.

Memory 904 can include computer-readable media in the form of volatile memory, such as random-access memory (RAM) 908 and/or cache memory 910. Data processing system 900 also can include other removable/non-removable, volatile/non-volatile computer storage media. By way of example, storage system 912 can be provided for reading from and writing to a non-removable, non-volatile magnetic and/or solid-state media (not shown and typically called a “hard drive”), which may be included in storage system 912. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 906 by one or more data media interfaces. Memory 904 is an example of at least one computer program product.

Memory 904 is capable of storing computer-readable program instructions that are executable by processor 902. For example, the computer-readable program instructions can include an operating system, one or more application programs, other program code, and program data. The computer-readable program instructions may include or implement architecture 100 or another architecture variation similar to that of architecture 100 as described in connection with FIG. 1.

Processor 902, in executing the computer-readable program instructions, is capable of performing the various operations described herein that are attributable to a computer. It should be appreciated that data items used, generated, and/or operated upon by data processing system 900 are functional data structures that impart functionality when employed by data processing system 900. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

Data processing system 900 may include one or more Input/Output (I/O) interfaces 918 communicatively linked to bus 906. I/O interface(s) 918 allow data processing system 900 to communicate with one or more external devices and/or communicate over one or more networks such as a local area network (LAN), a wide area network (WAN), and/or a public network (e.g., the Internet). Examples of I/O interfaces 918 may include, but are not limited to, network cards, modems, network adapters, hardware controllers, etc. Examples of external devices also may include devices that allow a user to interact with data processing system 900 (e.g., a display, a keyboard, and/or a pointing device) and/or other devices such as accelerator card.

Data processing system 900 is only one example implementation. Data processing system 900 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 9 is not intended to suggest any limitation as to the scope of use or functionality of example implementations described herein. Data processing system 900 is an example of computer hardware that is capable of performing the various operations described within this disclosure. In this regard, data processing system 900 may include fewer components than shown or additional components not illustrated in FIG. 9 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular embodiments only and is not intended to be limiting. Notwithstanding, several definitions are provided below.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of computer-readable storage media. A non-exhaustive list of examples of computer-readable storage media include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “responsive to” and similar language as described above, e.g., “if,” “when,” or “upon,” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The terms “individual” and “user” each may refer to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or media) having computer-readable program instructions thereon for causing a processor to carry out aspects of the inventive arrangements described herein. Within this disclosure, the terms “program code,” “computer-readable program code,” “computer-readable program instructions,” and “program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating, by computer hardware, bias information for a circuit design, wherein the bias information specifies switching information for a plurality of instances of one or more standard cells of the circuit design;
generating, by the computer hardware, a schedule specifying switching for the plurality of instances of the circuit design based on the bias information; and
performing, by the computer hardware, a dynamic voltage analysis on the circuit design to generate dynamic voltage analysis results by switching the plurality of instances of the circuit design based on the schedule.

2. The method of claim 1, wherein the generating the bias information for the circuit design comprises:
calculating measures of risk for the plurality of instances;
ranking the plurality of instances based on the measures of risk; and
assigning switching weights to one or more of the plurality of instances based on the measures of risk.

3. The method of claim 2, wherein the schedule is generated based on the switching weights.

4. The method of claim 3, wherein the switching weights increase a probability of two or more instances of the plurality of instances switching simultaneously during the dynamic voltage analysis.

5. The method of claim 1, wherein the bias information for the circuit design includes a victim instance of the plurality of instances and a list of one or more aggressor instances for the victim instance.

6. The method of claim 5, wherein the schedule includes instructions causing the victim instance to switch simultaneously with the one or more aggressor instances.

7. The method of claim 1, wherein the bias information for the circuit design is generated on a per-instance basis and, for each instance, is based on temporal proximity.

8. The method of claim 1, wherein the bias information for the circuit design is generated on a per-instance basis and, for each instance, is based on spatial proximity.

9. The method of claim 1, further comprising:
modifying the circuit design in response to the dynamic voltage analysis results indicating a voltage drop violation.

10. A system, comprising:
a memory capable of storing program instructions; and
a hardware processor capable of executing the program instructions to perform operations including:
generating bias information for a circuit design, wherein the bias information specifies switching information for a plurality of instances of one or more standard cells of the circuit design;
generating a schedule specifying switching for the plurality of instances of the circuit design based on the bias information; and
performing a dynamic voltage analysis on the circuit design to generate dynamic voltage analysis results by switching the plurality of instances of the circuit design based on the schedule.

11. The system of claim 10, wherein the generating the bias information for the circuit design comprises:
calculating measures of risk for the plurality of instances;
ranking the plurality of instances based on the measures of risk; and
assigning switching weights to one or more of the plurality of instances based on the measures of risk.

12. The system of claim 11, wherein the schedule is generated based on the switching weights.

13. The system of claim 12, wherein the switching weights increase a probability of two or more instances of the plurality of instances switching simultaneously during the dynamic voltage analysis.

14. The system of claim 10, wherein the bias information for the circuit design includes a victim instance of the plurality of instances and a list of one or more aggressor instances for the victim instance.

15. The system of claim 14, wherein the schedule includes instructions causing the victim instance to switch simultaneously with the one or more aggressor instances.

16. The system of claim 10, wherein the bias information for the circuit design is generated on a per-instance basis and, for each instance, is based on temporal proximity.

17. The system of claim 10, wherein the bias information for the circuit design is generated on a per-instance basis and, for each instance, is based on spatial proximity.

18. The system of claim 10, wherein the hardware processor capable of executing the program instructions to perform operations including:
modifying the circuit design in response to the dynamic voltage analysis results indicating a voltage drop violation.

19. A computer program product comprising one or more computer readable storage mediums having program instructions embodied therewith, wherein the program instructions are executable by computer hardware to cause the computer hardware to perform executable operations comprising:
generating bias information for a circuit design, wherein the bias information specifies switching information for a plurality of instances of one or more standard cells of the circuit design;
generating a schedule specifying switching for the plurality of instances of the circuit design based on the bias information; and
performing a dynamic voltage analysis on the circuit design to generate dynamic voltage analysis results by switching the plurality of instances of the circuit design based on the schedule.

20. The computer program product of claim 19, wherein the program instructions are executable by the computer hardware to cause the computer hardware to perform executable operations comprising:
modifying the circuit design in response to the dynamic voltage analysis results indicating a voltage drop violation.
